(19) United States
(12) Patent Application Publication
(10) Pub. No.: US 2014/0329543 A1
(43) Pub. Date: Nov. 6, 2014

(54) RADIO COMMUNICATION DEVICE, RADIO COMMUNICATION SYSTEM, AND POSITION ESTIMATION METHOD

(71) Applicant: NTT DOCOMO, INC., Chiyoda-ku, Tokyo (JP)

(72) Inventors: Kouki Hayashi, Chiyoda-ku (JP); Masanori Ishida, Chiyoda-ku (JP); Kunio Yoshikawa, Chiyoda-ku (JP)

(73) Assignee: NTT DOCOMO, INC., Chiyoda-ku, Tokyo (JP)

(21) Appl. No.: 14/366,422

(22) PCT Filed: Jan. 29, 2013
(86) PCT No.: PCT/JP2013/051929

§ 371 Date: Jun. 18, 2014

(30) Foreign Application Priority Data
Feb. 22, 2012 (JP) 2012-036680

(51) Int. Cl. H04W 4/02

(52) U.S. Cl. CPC H04W 4/02; H04W 4/008
USPC 455/456.1

(57) ABSTRACT

A radio communication device performs radio communication with a tag which includes a first short-range radio communication module, wherein the radio communication device includes a second short-range radio communication module that measures electric field strength of a radio wave from the tag, a sensor that detects a motion of the radio communication device, a location estimation unit that estimates a location of the tag, based on the electric field strength measured by the second short-range radio communication module, and the motion of the radio communication device detected by the sensor, and an output unit that outputs information indicating the location of the tag, wherein the location of the tag is estimated by the location estimation unit.

### TECHNICAL FIELD

The present invention relates to a radio communication system.

### BACKGROUND ART

A location information providing service has been known in which Global Positioning System (GPS) is utilized.

For example, a person who is subjected to positioning may be provided with a terminal having a built-in GPS receiver, or the terminal having the built-in GPS receiver may be attached to a target of positioning. When the location information is provided, the person subject to the positioning or the target of the positioning is identified based on a position of the GPS receiver, which is included in the terminal.

Further, there is provided a small tag which utilizes a short-range radio communication standard, such as Bluetooth (registered trade mark). For example, there is provided a small tag which utilizes the “Bluetooth Low Energy Wireless Technology.” When the small tag is separated from a target, which is to be prevented from losing, by a predetermined distance, the small tag warns.

Further, there is a method of estimating a location of a tag by a position of a GPS module. Here, in addition to a radio module, the GPS module is included in the tag.

Electric field strength from a radio module included in a tag is measured at three points for which corresponding positions are identified. There is a method of estimating a location of the radio module based on triangulation by using the electric field.

Additionally, a technique has been known (c.f. Patent Document 1, for example) in which a reader or an Access Point (AP) can precisely follow a location of a tag.

### RELATED ART DOCUMENT

### Patent Document

[Patent Document 1] PCT Japanese Translation Patent Publication No. 2011-507317

### SUMMARY OF THE INVENTION

### Problem to be Solved by the Invention

It is considered to retrieve location information of a small item, such as a remote controller or a key, by using the above-described location information providing service.

For utilizing this service, it is necessary to attach the terminal to the small item. However, in this case, the terminal is too large to be attached to the item. Thus, it is difficult to attach the terminal to the small item, such as the remote controller or the key. Consequently, it is not suitable to utilize this service for searching for a small item.

Additionally, even if a small tag warns, for which a short-range radio communication standard is utilized, when the small tag is separated from a target, which is to be prevented from losing, by a predetermined distance, a location of the small tag may not be detected.

The present invention has been achieved in view of the above-described points, and an object of the present invention is to provide a technique for estimating a location of a tag.

### Means for Solving the Problem

In order to solve the above-described problem, a radio communication device according to the present invention is a radio communication device that performs radio communication with a tag including a first short-range radio communication module. The radio communication device includes a second short-range radio communication module that measures electric field strength of a radio wave from the tag; a sensor that detects a motion of the radio communication device; a location estimation unit that estimates a location of the tag based on the electric field strength measured by the second short-range radio communication module and the motion of the radio communication device detected by the sensor; and an output unit that outputs information indicating the location of the tag, the location of the tag being estimated by the location estimation unit.

The sensor may include a gyro sensor and a geomagnetic sensor, and the location estimation unit may be configured to estimate a second direction in which the tag is located, based on the electric field strength measured by the second short-range radio communication module and a first direction which is identified based on information from the gyro sensor and the geomagnetic sensor.

The location estimation unit may be configured to estimate a distance between the radio communication device and the tag, based on the electric field strength measured by the second short-range radio communication module.

The sensor may include an acceleration sensor, and the location estimation unit may be configured to estimate a start and an end of the motion of the radio communication device, based on acceleration information measured by the acceleration sensor.

The first short-range radio communication module and the second short-range radio communication module may be configured to conform to at least one of a Bluetooth standard, a ZigBee standard, a Wi-Fi standard, and an ANT+ standard.

A radio communication system according to the present invention is a radio communication system including a tag which includes a first short-range radio communication module; and a radio communication device that performs radio communication with the tag. The radio communication system is achieved such that the tag includes the first short-range radio communication module that performs the radio communication with the radio communication device, and the radio communication device includes a second short-range radio communication module that measures electric field strength of a radio wave from the tag; a sensor that detects a motion of the radio communication device; a location estimation unit that estimates a location of the tag, based on the electric field strength measured by the second short-range radio communication module and the motion of the radio communication device detected by the sensor; and an output unit that outputs information indicating the location of the tag, the location of the tag being estimated by the location estimation unit.

Furthermore, it may be configured as a location estimation method performed by the radio communication device.

### Effect of the Present Invention

According to a disclosed embodiment, a location of a tag may be estimated.

### BRIEF DESCRIPTION OF THE DRAWINGS

FIG. 1 is a diagram showing one example of a radio communication system;

FIG. 2 is a diagram showing one example of a tag;

FIG. 3 is a diagram showing one example of a radio communication device;

FIG. 4 is a functional block diagram showing one example of the radio communication device;

FIG. 5 is a diagram showing a relationship between electric field strength and a distance;

FIG. 6 is a diagram showing one example of a motion of the radio communication device itself;

FIG. 7 is a diagram showing one example of values, which are detected by corresponding sensors;

FIG. 8 is a diagram showing one example in which the motion of the device itself is initiated;

FIG. 9 is a diagram showing one example that is in a middle of the motion of the device itself;

FIG. 10 is a diagram showing one example in which the motion of the device itself is terminated;

FIG. 11 is a diagram showing a display example of locations of the tags; and

FIG. 12 is a flowchart showing one example of the motion of the radio communication device.

### EMBODIMENTS FOR CARRYING OUT THE INVENTION

Next, there is explained a configuration for implementing the present invention, based on an embodiment below, while referring to the accompanying drawings. In all the drawings for explaining the embodiment, the same symbols are used for corresponding entities having the same functions, and thereby repeated explanations are omitted.

### Embodiment

<Radio Communication System>

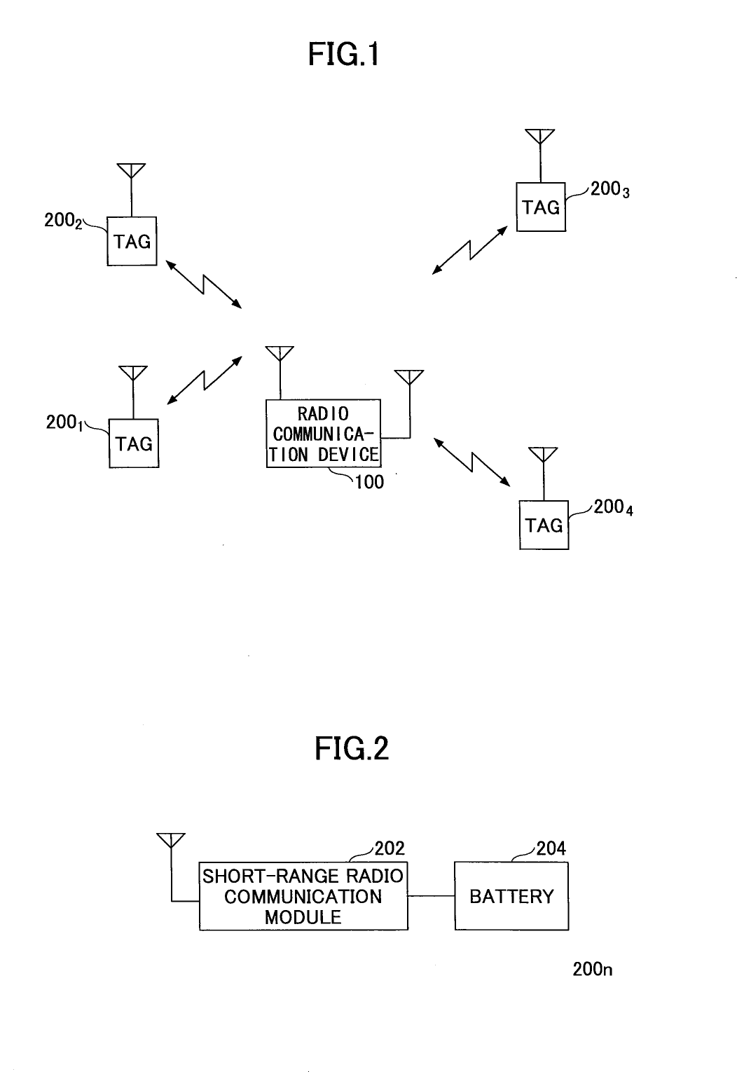

FIG. 1 shows an example of a radio communication system.

The example of the radio communication system includes a radio communication device 100; and a tag 200ₙ (n is an integer which satisfies 1≦n≦m (m is an integer greater than or equal to 1). FIG. 1 shows a case in which m=4, as an example. The value of m may be 1, 2 or 3, or the value of m may be greater than or equal to 5.

The tag 200ₙ may be referred to as a “cordless extension unit.” The tag 200ₙ includes a short-range radio communication module. The tag 200ₙ may be attached to various types of items. For example, the tag 200ₙ may be attached to something, which is not to be lost. In the example of the radio communication system, the tags 200ₙ are attached to a key, a remote controller, an umbrella, a purse, and the like.

The radio communication device 100 may be referred to as a “base unit.” The radio communication device 100 includes a short-range radio communication module, and a sensor. The short-range radio communication module of the radio communication device 100 performs radio communication with the short-range radio communication module of the tag 200ₙ. The radio communication device 100 measures electric field strength of a radio wave from the tag 200ₙ. The sensor detects a moving state of the radio communication device 100. The radio communication device 100 estimates a location of the tag 200ₙ, based on the electric field strength of the radio wave from the tag 200ₙ, and the moving state detected by the sensor. The radio communication device 100 displays the location of the tag 200ₙ.

<Tag 200ₙ>

FIG. 2 shows an example of the tag 200ₙ.

In the example of the radio communication system, the tag 100₁ is attached to a key; the tag 200₂ is attached to a remote controller; the tag 200₃ is attached to an umbrella; and the tag 200₄ is attached to a purse.

The tag 200ₙ includes the short-range radio communication module 202; and a battery 204. The short-range radio communication module 202 performs the radio communication in accordance with a short-range radio communication standard, such as Bluetooth (registered trademark), ZigBee, Wi-Fi, or ANT+. It is not limited to Bluetooth, ZigBee, Wi-Fi, or ANT+, and the short-range radio communication module may perform radio communication in accordance with a short-range radio communication standard other than these. The battery 204 supplies power to the short-range radio communication module 202. In the one example of the tag 200ₙ, a case is explained in which a radio communication module conforming to the Bluetooth standard is utilized as the short-range radio communication module 202.

<Radio Communication Device 100>

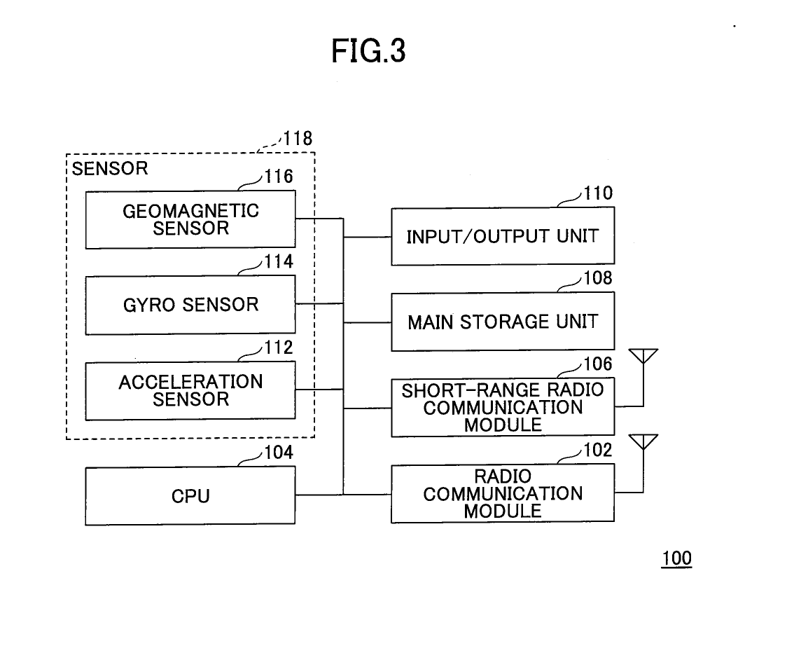

FIG. 3 shows one example of the radio communication device 100.

The radio communication device 100 may be any suitable terminal, with which a user can perform communication. Examples of the radio communication device 100 include user terminals, such as a mobile phone; an information terminal; a personal digital assistant; a mobile personal computer; and a smart phone. However, the radio communication device 100 is not limited to these.

The radio communication device 100 includes a radio communication module 102; a CPU 104; the short-range radio communication module 106; a main storage unit 108; an input/output unit 110; and the sensor 118.

The radio communication module 102 performs radio communication with a base station (not shown in the figure).

The CPU 104 performs control of the radio communication module 102; the short-range radio communication module 106; the main storage unit 108; the input/output unit 110; and the sensor 118. The CPU 104 functions in accordance with a program, which is stored in the main storage unit 108, and the CPU 104 executes a predetermined process. Specifically, the CPU 104 estimates a location of the tag 200ₙ, based on the electric field strength of the radio wave from the tag 200ₙ, and information indicating a moving state, which is detected by the sensor 118. The location of the tag 200ₙ, which is estimated by the CPU 104, may be a relative position to the radio communication device 100. The CPU 104 outputs the information indicating the location of the tag 200ₙ to the input/output unit 110.

The short-range radio communication module 106 performs radio communication in accordance with a short-range radio communication standard, such as Bluetooth, ZigBee, Wi-Fi, or ANT+. It is not limited to Bluetooth, ZigBee, Wi-Fi, or ANT+, and the short-range radio communication module 106 may perform the radio communication in accordance with a short-range radio communication standard other than these. In the one example of the radio communication device 100, a case is explained, in which a radio communication module conforming to the Bluetooth standard is utilized as the short-range radio communication module 106. Additionally, the short-range radio communication module 106 measures the electric field strength, based on the radio wave from the tag 200ₙ. For example, the short-range radio communication module 106 may measure received signal strength (RSSI: Received Signal Strength Indication, or Received Signal Strength Indicator), based on the radio wave from the tag 200ₙ.

The main storage unit 108 includes an application and an operating system (OS: Operating System). The application is software which includes a function to execute a task, the task which is to be executed by the user on the radio communication device 100. The OS is software which provides an interface abstracting hardware to the application software in the radio communication device 100.

The input/output unit 110 includes, for example, a keyboard and a mouse. The input/output unit 110 is a device for inputting a command or data to the radio communication device 100. Further, the input/output unit 110 may include a touch panel. Furthermore, the input/output unit 110 may include a microphone, for example, and the input/output unit 110 may input a voice of a user. The voice includes a message to a recipient, or a command to the radio communication device 100. The command includes a command to the OS and a command to the application.

Further, the input/output unit 110 may include a display, for example, and the input/output unit 110 may display a processing state or a processed result by the radio communication device 100. Alternatively or additionally, the input/output unit 110 may include a speaker, for example, and the input/output unit 110 may output sound to the user. The processing state or the processed result includes those by the OS or by the application. The display includes a liquid crystal display (LCD), a Cathode Ray Tube (CRT), a Plasma Display Panel (PDP), an organic Electro-Luminescence (EL) display, or the like.

The sensor 118 includes a moving state sensor, and the sensor 118 detects a motion of the radio communication device 100. In one example, the moving state sensor includes an acceleration sensor 112, a gyro sensor 114, a geomagnetic sensor 116, and the like. It is not limited to the acceleration sensor 112, the gyro sensor 114, or the geomagnetic sensor 116, and a sensor other than these may be included.

<Functions of the Radio Communication Device 100>

There is explained one example of functions of the radio communication device 100.

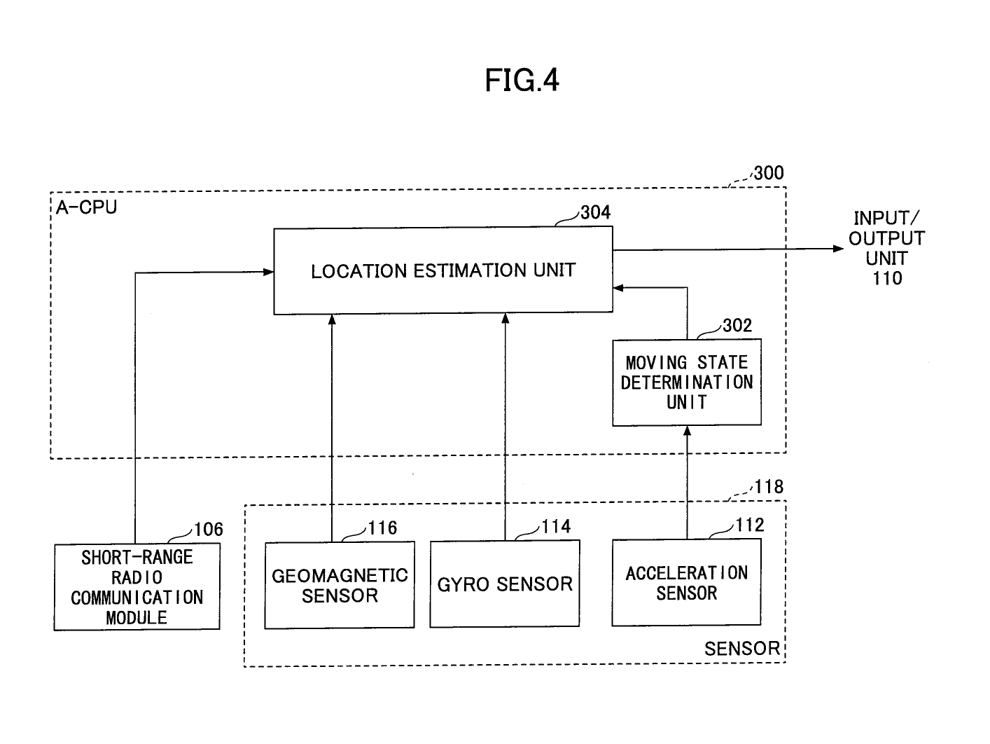

FIG. 4 is a functional block diagram showing one example of the radio communication device 100. The functions which are represented by the functional block diagram are mainly executed by the CPU 104. Namely, the functions which are represented by the functional block diagram of FIG. 4 are executed by the CPU 104 in accordance with the application stored in the main storage unit 108. The CPU may be called an “A-CPU (application-CPU),” the CPU which executes the functions represented by the functional block diagram of FIG. 4 in accordance with the application stored in the main storage unit.

The CPU 104 functions as a moving state determination unit 302. Information indicating acceleration is input from the acceleration sensor 112 to the moving state determination unit 302. The moving state determination unit 302 determines whether the radio communication device 100 moves, based on the information indicating the acceleration from the acceleration sensor 112. The moving state determination unit 302 inputs information indicating whether the radio communication device 100 moves into the location estimation unit 304.

The CPU 104 functions as the location estimation unit 304. The information indicating whether the radio communication device 100 moves is input from the moving state determination unit 302 to the location estimation unit 304. The location estimation unit 304 detects timing at which the motion of the radio communication device 100 is initiated and timing at which the motion of the radio communication device 100 is terminated, based on the information from the moving state determination unit 302. Subsequent to detecting the timing at which the motion of the radio communication device 100 is initiated and the timing at which the motion of the radio communication device 100 is terminated, the location estimation unit 304 estimates, in a time period between the timing of the initiation of the motion and the timing of the termination of the motion, a location of the tag 200ₙ, based on the electric field strength which is detected by the short-range radio communication module 106, information indicating a direction of geomagnetism which is detected by the geomagnetic sensor 116, and information indicating angular acceleration which is detected by the gyro sensor 114.

The location estimation unit 304 estimates a distance between the radio communication device 100 and the tag 200ₙ, based on the information indicating the electric field strength from the short-range radio communication module 106. Specifically, the location estimation unit 304 may have a database which includes a relationship between the electric field strength and the distance.

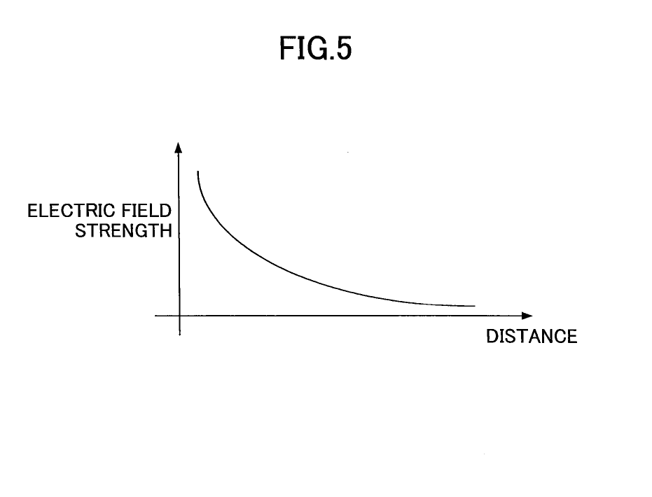

FIG. 5 shows the relationship between the electric field strength and the distance. FIG. 5 shows that the greater the electric field strength is, the smaller (closer) the distance between the radio communication device 100 and the tag 200ₙ becomes; and that the smaller the electric field strength is, the greater (more distant) the distance between the radio communication device 100 and the tag 200ₙ becomes. Based on FIG. 5, the table may be prepared in which the electric field strength is associated with the distance.

The location estimation unit 304 estimates the distance between the radio communication device 100 and the tag 200ₙ, based on the relationship between the electric field strength and the distance stored in the database.

The location estimation unit 304 calculates a direction of the radio communication device 100, based on the information indicating the direction of the geomagnetism from the geomagnetic sensor 116. The location estimation unit 304 calculates an angle and a rotational speed of the radio communication device 100, based on the information indicating the angular speed from the gyro sensor 114.

The location estimation unit 304 estimates a location of the tag 200ₙ, based on the estimated value of the distance, the information indicating the direction, and the information indicating the angle and the rotational speed. The location estimation unit 304 inputs the information indicating the estimated location of the tag 200ₙ into the input/output unit 110.

The input/output unit 110 displays the location of the tag 200ₙ, based on the information indicating the location of the tag 200ₙ from the location estimation unit 304.

<Method of Estimating the Location of the Tag 200ₙ>

The radio communication device 100 activates an application for estimating the location of the tag 200ₙ. When the application for estimating the location of the tag 200ₙ is activated, a message is output, which prompts to move the radio communication device 100. A message which prompts to shake the radio communication device 100 itself may be output, or a message which prompts to tilt the radio communication device 100 itself may be output. For example, a message, such as “please move the radio communication device so as to draw a circle around the body, approximately in 5 seconds,” is output. A user may be informed by sound, or the user may be informed by displaying.

The user moves the radio communication device 100 in accordance with the message.

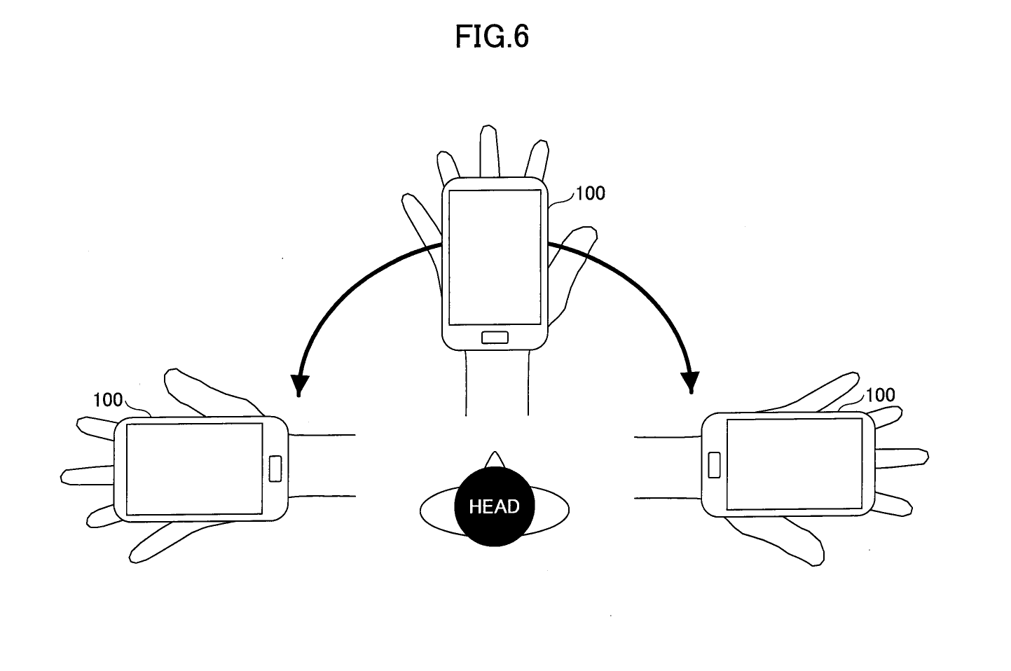

FIG. 6 shows an example in which the user moves the radio communication device 100 in accordance with the message. The user turns around the user himself/herself, while placing the radio communication device 100 on a palm.

The process of estimating the location of the radio communication device 100 may be started after the radio communication device 100 is turned around the user himself/herself, or the process of estimating the location of the radio communication device 100 may be executed in real time during turning around. In one example of the radio communication device 100, a case is explained in which the process is started after turning around the radio communication device 100.

The location estimation unit 304 detects timing of initiation of the motion of the radio communication device 100 and timing of termination of the motion of the radio communication device 100, based on the information from the moving state determination unit 302, the information which indicates whether the radio communication device 100 moves. When the location estimation unit 304 detects the timing of the initiation of the motion and the timing of the termination of the motion, the location estimation unit 304 retrieves the electric field strength which is detected by the short-range radio communication module 106, the information indicating the direction of the geomagnetism which is detected by the geomagnetic sensor 116, and the information indicating the angular speed which is detected by the gyro sensor 114, during the time period between the timing of the initiation of the motion and the timing of the termination of the motion.

The location estimation unit 304 estimates the direction of the radio communication device 100 based on the information indicating the direction of the geomagnetism. The location estimation unit 304 calculates the angle and the rotational speed from the information indicating the angular acceleration, and the location estimation unit 304 estimates a moving state of the radio communication device 100 from the angle and the rotational speed. The location estimation unit 304 estimates the distance between the radio communication device 100 and the tag 200ₙ, based on the information indicating the electric field strength. Instead of estimating the direction of the radio communication device 100 based on the information indicating the direction of the geomagnetism, the location estimation unit 304 may calculate the angle and the rotational speed from the information indicating the angular acceleration, and the location estimation unit 304 may estimate the moving state of the radio communication device 100, based on the angle and the rotational speed. In this manner, the relative location from the initiation of the motion can be estimated.

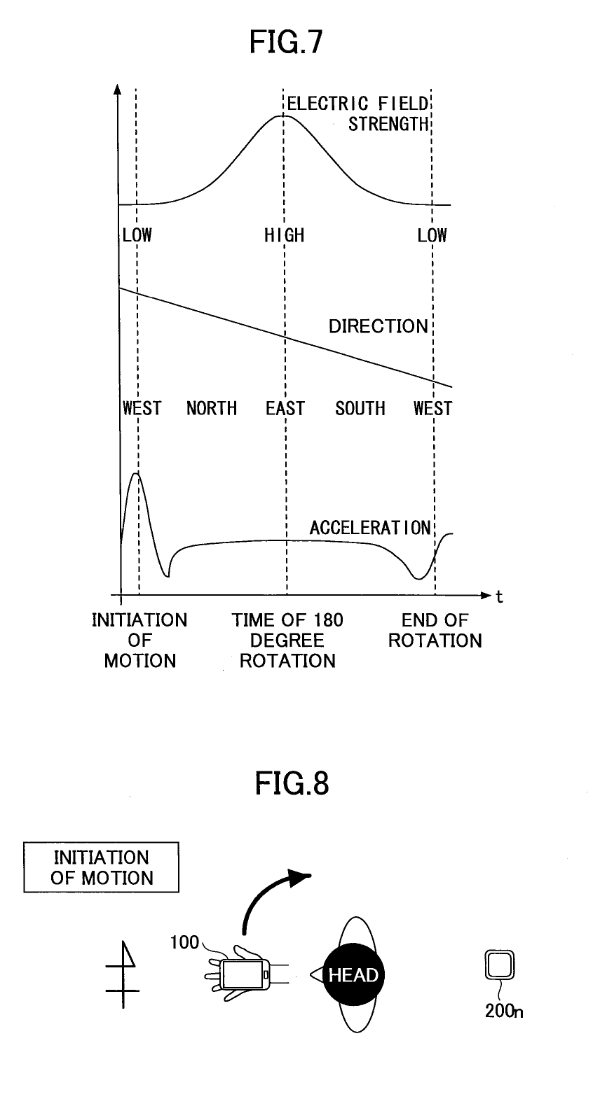

FIG. 7 shows one example of variations of values detected by the corresponding sensors, when the radio communication device 100 is moved. FIG. 7 shows, from the bottom, the acceleration which is detected by the acceleration sensor 112, the direction detected by the gyro sensor 114 and the geomagnetic sensor 116, and the electric field strength detected by the short-range radio communication device 106.

FIGS. 8-10 show the motion such that the user turns the radio communication device 100 around the user himself/herself. FIGS. 8-10 show a case in which the tag 200ₙ is located in a direction which is opposite to a direction in which the user is directed, at a moment at which the motion is initiated.

When the user starts moving the radio communication device 100, acceleration in the horizontal direction significantly varies. Here, the acceleration in the horizontal direction is detected by the acceleration sensor 112. This corresponds to the “initiation of the motion” in FIGS. 7 and 8. The moving state determination unit 302 inputs information indicating the motion into the location estimation unit 304.

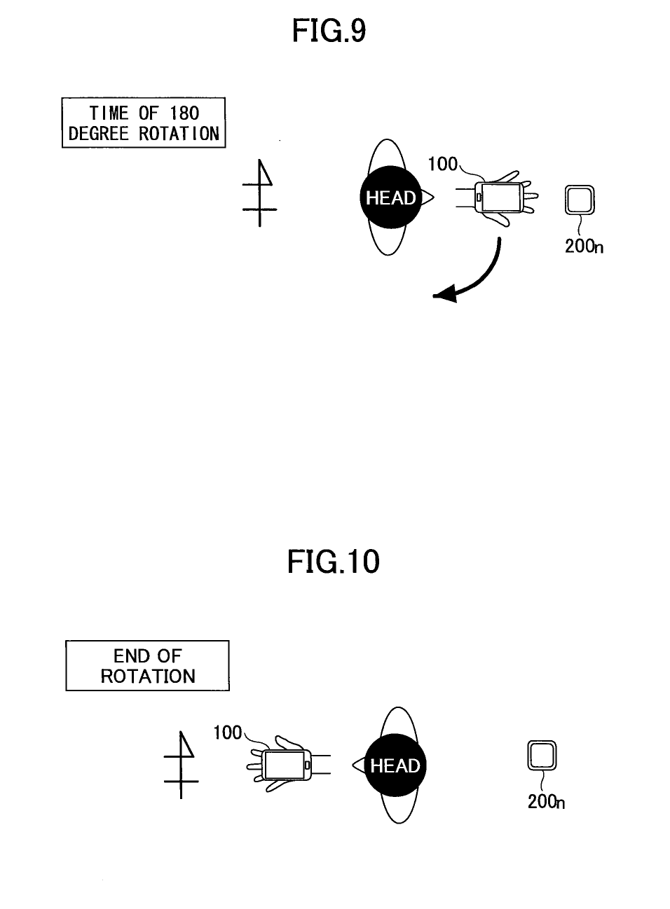

When the user continues moving the radio communication device 100, variation of the acceleration detected by the acceleration sensor 112 becomes small. This continues after the “initiation of the motion” of FIGS. 7 and 8 until the “end of the rotation” of FIGS. 7 and 10, through the “time of 180 degree rotation” of FIGS. 7 and 9.

When the user continues further moving the radio communication device 100, and one rotation is completed, the variation of the acceleration, which is detected by the acceleration sensor 112, becomes greater. This corresponds to the “end of the rotation” in FIG. 7. The moving state determination unit 302 inputs information, which indicates that it is not moving, into the location estimation unit 304.

The location estimation unit 304 detects the timing at which the motion of the radio communication device 100 is initiated and the timing at which the motion of the radio communication device 100 is terminated by the information indicating whether the radio communication device 100 is moved, the information which is from the moving state determination unit 302.

When the timing of the initiation of the motion and the timing of the termination of the motion are detected, the location estimation unit 304 starts estimating the location of the tag 200ₙ.

At the “initiation of the motion,” the location estimation unit 304 estimates that the user is directed to the west, for example, by the direction which is detected by the geomagnetic sensor 116. Further, at the “initiation of the motion,” since the user is positioned between the tag 200ₙ and the radio communication terminal 100, the value of the electric field strength, which is detected by the short-range radio communication module 106, becomes a low value. The location estimation unit 304 estimates the distance between the tag 200ₙ and the radio communication device 100, based on the electric field strength from the short-range radio communication module 106.

Further, the location estimation unit estimates the angle and the rotational speed of the radio communication device 100, based on the information indicating the angular speed from the gyro sensor 114, after the “initiation of the motion” until the end of the rotation. By estimating the angle and the rotational speed of the radio communication device 100 based on the information indicating the angular speed from the gyro sensor 114, a relative motion from the “initiation of the motion” can be estimated.

Further, the location estimation unit 304 may estimate the direction in which the radio communication device 100 is directed, based on the direction which is detected by the geomagnetic sensor 116. In the example shown in FIG. 7, the radio communication device 100 estimates, for example, that the user is directed to a direction between the west and the north, or between the north and the east.

Further, since the distance between the tag 200ₙ and the radio communication terminal 100 becomes smaller, the electric intensity, which is detected by the short-range radio communication module 106, gradually increases. The electric field intensity, which is detected by the short range radio communication module 106, becomes large, when there are no obstacles between the tag 200ₙ and the radio communication terminal 100. The location estimation unit 304 estimates the distance between the tag 200ₙ and the radio communication device 100, based on the electric field intensity from the short-range radio communication module 106. Further, the location estimation unit 304 detects the direction in which the radio communication device 100 is directed, based on the electric field strength from the short-range radio communication module 106 and the information indicating the angular speed from the gyro sensor 114. Further, the location estimation unit 304 may detect the direction in which the radio communication device 100 is directed, based on the electric field intensity from the short-range radio communication module 106, the information indicating the angular speed from the gyro sensor 114, and the direction from the geomagnetic sensor 116. Specifically, since, at the “time of 180 degree rotation,” there are no obstacles between the tag 200ₙ and the radio communication terminal 100 and the distance becomes the smallest, the electric field strength detected by the short-range radio communication module 106 becomes the maximum. The location estimation unit 304 estimates the distance between the tag 200ₙ and the radio communication device 100, based on the electric field intensity from the short-range radio communication module 106. Additionally, when the electric field intensity, which is detected by the short-range radio communication module 106, is the maximum, the location estimation unit 304 determines the direction which is calculated based on the angular speed detected by the gyro sensor 114 and the direction detected by the geomagnetic sensor 116 to be the direction in which the radio communication device 100 is directed.

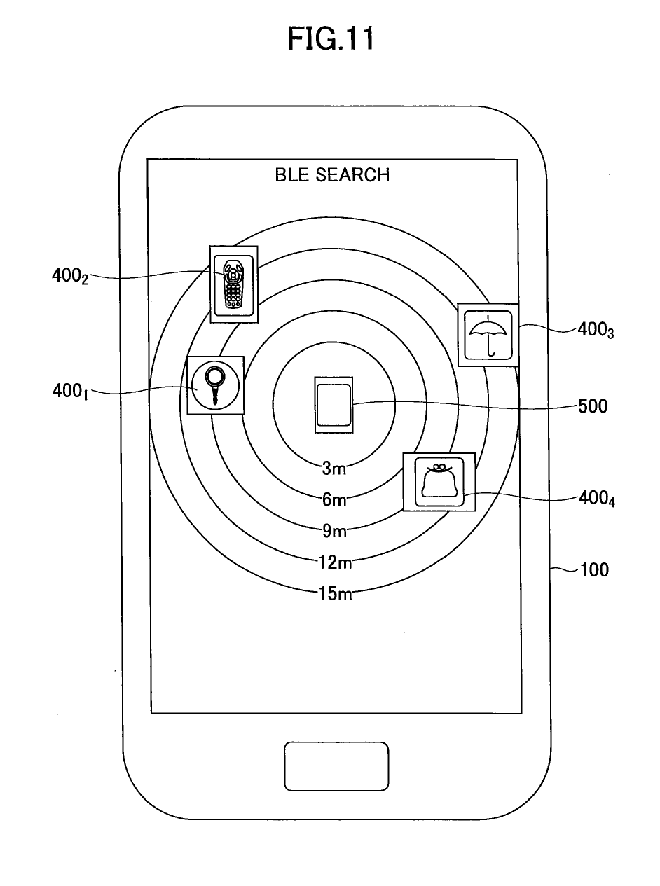

FIG. 11 shows an example of displaying the estimated location of the tag 200ₙ on the input/output unit 110.

According to the display example shown in FIG. 11, an icon 500 representing the radio communication device 100, and icons 400₁, 400₂, 400₃, and 400₄ corresponding to the detected tags 200₁, 200₂, 200₃, and 200₄ are displayed. The icons 400₁, 400₂, 400₃, and 400₄ are displayed at the corresponding positions relative to the icon 500 of the radio communication device 100, based on the direction and the distance which are estimated by the location estimation unit 304.

<Operation of the Radio Communication Device 100>

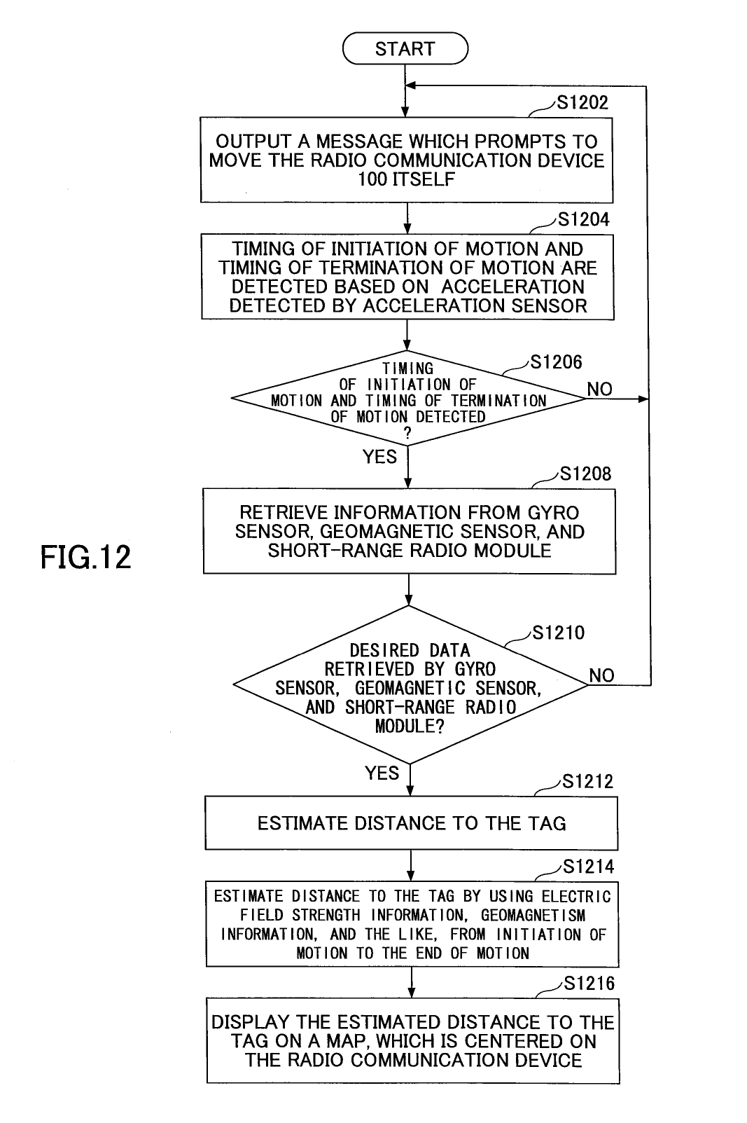

FIG. 12 shows one example of an operation of the radio communication device 100.

Prior to executing estimation of the location of the tag 200ₙ by the radio communication device 100, a process for identifying each other is executed between the short-range radio communication module 202 of the tag 200ₙ and the short-range radio communication module 106 of the radio communication device 100.

For example, pairing may be executed between the short-range radio communication module 202 of the tag 200ₙ and the short-range radio communication module 106 of the radio communication device 100.

Specifically, one of the short-range radio communication module 202 and the short-range radio communication module 106 of the radio communication device 100 is set to be a “searchable (detectable) state. Additionally, the settings of authentication and encryption are matched with each other. A “search (detection)” operation is executed from the other device, for which the “searchable (detectable) state” is not set. Since a list of neighboring devices which are in the searchable state is provided, a desired connection counter party is specified among them. The same pass key is input to the both parties. For specifying the desired connection counter party, information is also specified, which indicates what the connection counter party is. Specifically, when the connection counter party is the tag 200ₙ, the tag 200ₙ may be specified together with the information, which indicates as to what the tag 200ₙ is attached to.

Further, for example, the identifier of the tag 200ₙ may be associated with the list of the neighboring devices, which is provided to the radio communication device 100 when the “search” operation is performed. Specifically, a MAC address of the short-range radio communication module 202 of the tag 200ₙ is associated with the identifier of the tag 200ₙ. Further, the tag 200ₙ may be specified together with the identifier of the tag 200ₙ and the information indicating as to what the tag 200ₙ is attached to.

By executing the process, it is possible to find as to what the tag 200ₙ is attached to. Thus, it can be a clue for finding what is lost.

At step S1202, the radio communication device 100 outputs a message to the user. Here, the message prompts to move the radio communication device 100. Specifically, the input/output unit 110 outputs a message, such as “please move the radio communication device so as to draw a circle around the body, approximately in 5 seconds.” A display may be prepared which is to be selected when the user starts moving, together with displaying of the message. Since the motion is started by pressing the display by the user, accuracy of detecting the timing of the initiation of the motion can be improved.

The user moves the radio communication device 100.

At step S1204, the moving state determination unit 302 detects the timing at which the motion is initiated and the timing at which the motion is terminated, based on the acceleration which is detected by the acceleration sensor 112.

At step S1206, the location estimation unit 304 determines whether the timing at which the motion is initiated and the timing at which the motion is terminated are detected.

At step S1208, when the timing at which the motion is initiated and the timing at which the motion is terminated are detected, the location estimation unit 304 retrieves information which is detected between the timing at which the motion is initiated and the timing at which the motion is terminated from the gyro sensor 114, the geomagnetic sensor 116, and the short-range radio communication module 106.

At step S1210, the location estimation unit 304 determines whether desired data is retrieved from the gyro sensor 114, the geomagnetic sensor 116, and the short-range radio communication module 106. Specifically, the location estimation unit 304 may determine as to whether the desired data is retrieved, based on the information detected by the geomagnetic sensor 116 and the information detected by the short-range radio communication module 106. For example, a determination may be made as to whether the information detected by the geomagnetic sensor 116 indicates the motion such that the radio communication device 100 is turned around, and as to whether a peak occurs in the electric field strength which is detected by the short-range radio communication module 106. When the peak occurs in the electric field strength, a determination is made that the desired data is retrieved. When no peaks occur in the electric field strength, a determination is made that the desired data is not retrieved. Various methods may be applied as a method of validating as to whether the desired data is retrieved.

When the determination is made at step S1210 that the desired data is not retrieved, the process returns to step S1202. The radio communication device 100 outputs the message to the user again, the message which prompts to move the radio communication device 100 itself. In this case, a message may be output, which prompts to shift the location, and prompts to move the radio communication device 100 itself. Specifically, the input/output unit 110 outputs a message, such as “after moving approximately 3 m, please move the radio communication device so as to draw a circle around the body, approximately in 5 seconds.”

At step S1212, when the determination is made that the desired data is retrieved, the location estimation unit 304 estimates the distance to the tag 200ₙ. Specifically, the location estimation unit 304 estimates the distance to the detected tag 200ₙ, based on the electric field strength which is detected by the short-range radio communication module 106.

At step S1214, the distance to the tag 200ₙ is estimated by using the electric field strength information and the geomagnetism information, from the initiation of the motion until the termination of the motion.

At step S1216, the estimated distance to the tag 200ₙ is displayed on a map, which is centered on the radio communication device 100.

The program which is for causing the CPU 104 to function as the radio communication device 100 is provided, for example, in a state in which it is recorded in a recording medium, such as a flexible disk, a CD-ROM, or a memory card. Alternatively, the program may be downloaded through a communication network. When the recording medium is inserted into an auxiliary storage device of a computer, the program stored in the storage medium is read out. The CPU 104 writes the read program in a RAM or a HDD, and the CPU executes processing. The program causes the computer to execute each of steps S1202-S1216 of FIG. 12. Alternatively, for example, the program may cause the computer to execute, at least, a portion of the steps.

According to the embodiment, a small tag including a short-range radio communication module is attached to something which is difficult to find when it is lost, such as a remote controller of a television, or a key. The small tag may have a key holder-like shape, for example. In an application of a radio communication device, such as a smart phone, an estimated location of the small tag, which may be a relative position between the smart phone and the small tag, for example, can be displayed. Accordingly, it can be a clue for finding a lost item.

According to the embodiment, the location of the tag can be estimated by the radio communication device, without mounting a sensor on the tag. The location of the tag includes a relative position to the radio communication device. Conventionally, when a tag does not include a sensor, such as that of GPS, a location of the tag may not be estimated by a radio communication device.

According to the one example of the radio communication system, the location of the tag can be estimated by using the sensor at the side of the radio communication device. Since the location of the tag can be estimated using the tag at the side of the radio communication device, the tag may be formed of the short-range radio communication module and the battery. Accordingly, the tag can be downsized, and the tag can be produced at low cost. Furthermore, power consumption of the tag can be reduced. Consequently, it becomes easier to attach tags to various things, and the service can be expanded.

Additionally, as another application example, it can be considered to apply it to a package tour. For example, it can be utilized by a tour conductor for managing participants of the tour. Specifically, by letting the participants carry tags.

Furthermore, as another application example, it can be applied to manage kindergarten children at a kindergarten, or students at a school. Specifically, by letting the kindergarten children or the students carry the tags.

Hereinabove, the radio communication device, the radio communication system, and the location estimation method are explained by the embodiment. However, the present invention is not limited to the above-described embodiment, and modification and improvements may be made within the scope of the present invention. For convenience of the explanation, the embodiment is explained by using the specific user terminal or the application so as to facilitate understanding of the present invention. However, these are simply illustrative, and any other appropriate user terminal or application may be used, except as indicated otherwise. For convenience of the explanation, the devices according to the embodiment of the present invention are explained by using functional block diagrams. However, these devices may be implemented in hardware, software, or combination thereof.

The present application is based on and claims the benefit of priority of Japanese Patent Application No. 2012-036680, filed on Feb. 22, 2012, the entire contents of which are hereby incorporated by reference.

### LIST OF REFERENCE SYMBOLS

100: Radio communication device
102: Radio communication module
104: CPU
106: Short-range radio communication module
108: Main storage unit
110: Input/output unit
112: Acceleration sensor
114: Gyro sensor
116: Geomagnetic sensor
118: Sensor
200ₙ (n is an integer satisfying 1≦n≦m (m is an integer greater than 1)): Tag
202: Short-range radio communication module
204: Battery
300: A-CPU
302: Moving state determination unit
304: Location estimation unit
400ₙ (n is an integer satisfying 1≦n≦m (m is an integer greater than 1)): Icon
500: Icon

1. A radio communication device that performs radio communication with a tag which includes a first short-range radio communication module, the radio communication device comprising:
a second short-range radio communication module that measures electric field strength of a radio wave from the tag;
a sensor that detects a motion of the radio communication device;
a location estimation unit that estimates a location of the tag, based on the electric field strength measured by the second short-range radio communication module, and the motion of the radio communication device detected by the sensor; and
an output unit that outputs information indicating the location of the tag, wherein the location of the tag is estimated by the location estimation unit.

2. The radio communication device according to claim 1,
wherein the sensor includes a gyro sensor and a geomagnetic sensor, and
wherein the location estimation unit estimates a second direction in which the tag is located, based on the electric field strength measured by the second short-range radio communication module, and a first direction which is determined based on information from the gyro sensor and the geomagnetic sensor.

3. The radio communication device according to claim 1,
wherein the sensor includes a gyro sensor, and
wherein the location estimation unit estimates a second direction in which the tag is located, based on the electric field strength measured by the second short-range radio communication module, and a first direction which is determined based on information from the gyro sensor.

4. The radio communication device according to claim 1,
wherein the location estimation unit estimates a distance between the radio communication device and the tag, based on the electric field strength measured by the second short-range radio communication module.

5. The radio communication device according to claim 1,
wherein the sensor includes an acceleration sensor, and
wherein the location estimation unit estimates a start and an end of the motion of the radio communication device, based on acceleration information measured by the acceleration sensor.

6. The radio communication device according to claim 1,
wherein the first short-range radio communication module and the second short-range radio communication module conform to at least one of a Bluetooth standard, a ZigBee standard, a Wi-Fi standard, and an ANT+ standard.

7. A radio communication system comprising:
a tag which includes a first short-range radio communication module; and
a radio communication device that performs radio communication with the tag,
wherein the tag includes the first short-range radio communication module that performs the radio communication with the radio communication device, and
wherein the radio communication device includes
a second short-range radio communication module that measures electric field strength of a radio wave from the tag;
a sensor that detects a motion of the radio communication device;
a location estimation unit that estimates a location of the tag, based on the electric field strength measured by the second short-range radio communication module, and the motion of the radio communication device detected by the sensor; and
an output unit that outputs information indicating the location of the tag, wherein the location of the tag is estimated by the location estimation unit.

8. A location estimation method of a radio communication device that performs radio communication with a tag including a first short-range radio communication module,
wherein the method measures electric field strength of a radio wave from the tag by a second short-range radio communication module;
detects a motion of the radio communication device by a sensor;
estimates a location of the tag, based on the electric field strength measured by the second short-range radio communication module, and the motion of the radio communication device detected by the sensor; and
outputs information indicating the estimated location of the tag.
